(19) United States
(12) Patent Application Publication
(10) Pub. No.: US 2026/0316274 A1
(43) Pub. Date: Oct. 15, 2026

(54) ROBOT OBSTACLE AVOIDANCE CONTROL METHOD, ROBOT CONTROL DEVICE AND COMPUTER-READABLE STORAGE MEDIUM

(71) Applicant: UBTECH ROBOTICS CORP LTD, Shenzhen (CN)

(72) Inventors: XUAN LUO, Shenzhen (CN); Chunyu Chen, Shenzhen (CN); Huan Tan, Shenzhen (CN); Youjun Xiong, Shenzhen (CN)

(21) Appl. No.: 19/690,110

(22) Filed: May 28, 2026

Related U.S. Application Data
(63) Continuation of application No. PCT/CN2023/142297, filed on Dec. 27, 2023.

(30) Foreign Application Priority Data
Nov. 28, 2023 (CN) 202311614707.7

(51) Int. Cl. B25J 9/16; G05B 19/4155

(52) U.S. Cl. CPC B25J 9/1666; B25J 9/1646; B25J 9/1651; G05B 19/4155; G05B 2219/40339

(57) ABSTRACT

A robot obstacle avoidance control method includes: obtaining actual spatial positions of obstacles in an operating environment of a target robot; constructing an RMP motion policy mapping tree including a root node corresponding to a robot joint space and leaf node tasks including a position motion task, an orientation motion task, and obstacle avoidance motion tasks for robot key parts; constructing geometric dynamical systems involving velocity information for the leaf node tasks; obtaining actual joint state information and desired position and orientation information of a robot end-effector; performing an RMP pushforward operation to obtain local desired inertia matrices and local desired forces for the leaf node tasks; performing an RMP pullback operation to solve for a desired joint acceleration of the target robot; and controlling movement of the target robot according to the desired joint acceleration.

### CROSS REFERENCE TO RELATED APPLICATIONS

The present application is a continuation-application of International Application PCT/CN2023/142297 with an international filing date of Dec. 27, 2023, which claims foreign priority to Chinese Patent Application No. 202311614707.7, filed on Nov. 28, 2023, in the China National Intellectual Property Administration, the contents of all of which are hereby incorporated by reference in its entirety.

### TECHNICAL FIELD

The present disclosure generally relates to the field of robot control technologies, and in particular, relates to a robot obstacle avoidance control method, robot control device, and robotic arm and computer-readable storage medium.

### BACKGROUND

With the continuous advancement of science and technology, robotics applications have become increasingly widespread across various industries. Consequently, robots are frequently required to navigate around—or “avoid”—various obstacles present within their operating environments while executing assigned tasks. This is essential to prevent issues such as physical damage to the robot caused by collisions, or the failure to successfully complete the intended operation. However, in actual operational scenarios, the obstacles within a robot's environment are not necessarily static; new obstacles frequently emerge, or existing ones shift their positions, thereby introducing dynamic obstacles into the operating environment. Therefore, ensuring that robots can execute their assigned tasks while avoiding these dynamic obstacles with both high agility and high real-time responsiveness constitutes a critical technical challenge within the contemporary field of robot control technology.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a robot control device according to one embodiment.

FIG. 2 is an exemplary flowchart of a robot obstacle avoidance control method according to another embodiment.

FIG. 3 is an exemplary flowchart illustrating substeps included in step S220 of FIG. 2.

FIG. 4 is a schematic diagram illustrating a tree structure of an RMP motion policy mapping tree according to one embodiment.

FIG. 5 is an exemplary flowchart illustrating substeps included in step S260 of FIG. 2.

FIG. 6 is a block diagram of a robot obstacle avoidance control module according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

Through rigorous research, the inventors of the present application identified that conventional methods for controlling robots to perform obstacle avoidance can be broadly classified into the following four categories.

Sampling-based Methods: These methods operate by randomly sampling points within the robot's operating environment to identify and expand collision-free regions. Once these regions have been expanded to encompass the target location, a collision-free path is automatically generated. The primary advantage of these methods lies in its completeness—specifically, if a collision-free path exists, a sampling-based method is guaranteed to find it. Consequently, it is well-suited for path-finding tasks in large-scale, complex environments. However, these methods offer no guarantees regarding path optimality (i.e., finding the shortest path) or velocity continuity; furthermore, the efficiency of its solution process is subject to significant randomness. Fundamentally, it is most effective for obstacle avoidance scenarios involving static obstacles.

Optimization-based methods: These methods establish a set of simple interpolated waypoints between the motion start point and the target point to serve as a reference. By imposing the constraint of “collision-freeness” upon these interpolated waypoints, a numerical optimization equation—formulated in terms of the robot's joint outputs—is constructed and solved. The advantage of this approach is its flexibility: the optimization equation can be refined to meet specific task requirements (e.g., minimizing path length or travel time). Once the corresponding optimization equation is solved, an ideal, collision-free trajectory is obtained. However, the quality and efficiency of the solution process in optimization-based methods are inversely correlated; consequently, this approach is typically employed as an offline planning method for static obstacle avoidance.

Stochastic Process-based Methods: These methods can be viewed as a hybrid of sampling-based and optimization-based approaches, the elements being sampled and optimized are Gaussian process parameters used to describe a continuous trajectory. The advantage of this approach is its inherent capacity for velocity continuity, as well as the ability to accelerate the optimization process through probabilistic inference techniques. Nevertheless, even with these capabilities, stochastic process-based methods are generally limited to performing rapid re-planning only after a newly introduced obstacle has been identified within the environment. Their solution speed is insufficient to enable real-time, online planning in the presence of dynamic obstacles.

Potential Field Methods: These methods are grounded in the concept of potential fields, treating the motion target point as an “attractive source” and obstacles as “repulsive sources” within the field. By calculating the superimposed potential energy resulting from these attractive and repulsive sources, the robot can be guided to move toward its target destination while simultaneously avoiding obstacles. The primary advantages of this approach are its algorithmic simplicity and rapid computation speed, which enable it to perform obstacle avoidance against dynamic obstacles to a certain extent. The reason for qualifying this as “to a certain extent” is that the potential field methods consider only the robot's positional state information. Consequently, the methods are highly susceptible to becoming trapped in local optima due to insufficient dynamic agility, rendering it fundamentally incapable of executing highly agile avoidance maneuvers against dynamic obstacles.

To address this issue, the embodiments of the present application provide a robot obstacle avoidance control method, a robot control device, and a computer-readable storage medium. By leveraging the rapid iterative solution capabilities of the RMP framework—along with the velocity continuity inherent in geometric dynamic systems that incorporate velocity information—these embodiments ensure that the robot achieves effective reactive obstacle avoidance against dynamic obstacles while executing its intended tasks. This approach enhances both the real-time responsiveness and the agility of the robot's obstacle avoidance capabilities, thereby enabling the robot to execute its desired operations while simultaneously performing highly agile and real-time avoidance maneuvers against dynamic obstacles.

Some embodiments of the present disclosure will be described in detail below with reference to the accompanying drawings. In the absence of conflict, the following embodiments and the features thereof may be combined with one another.

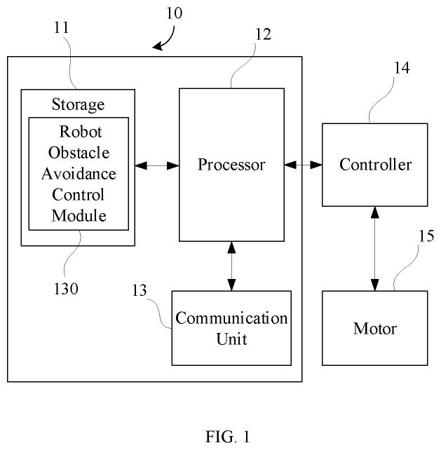

Referring to FIG. 1, in one embodiment, the robot control device 10 is communicatively connected to a target robot and is to control the motion state of the target robot, such that the target robot can rapidly and flexibly avoid dynamic obstacles within its operating environment while performing complex operational tasks. The robot control device 10 may be a computer device independent of the target robot, or may be a hardware module integrated with the target robot. The computer device may be, for example, a personal computer, a cloud server, a laptop computer, or a tablet computer. The target robot may be a redundant robot with a serial or parallel configuration employing position control, force control, or hybrid force-position control, or may be a redundant robotic arm, a quadruped robot, or a humanoid robot applied in fields such as industry, services, and special-purpose operations.

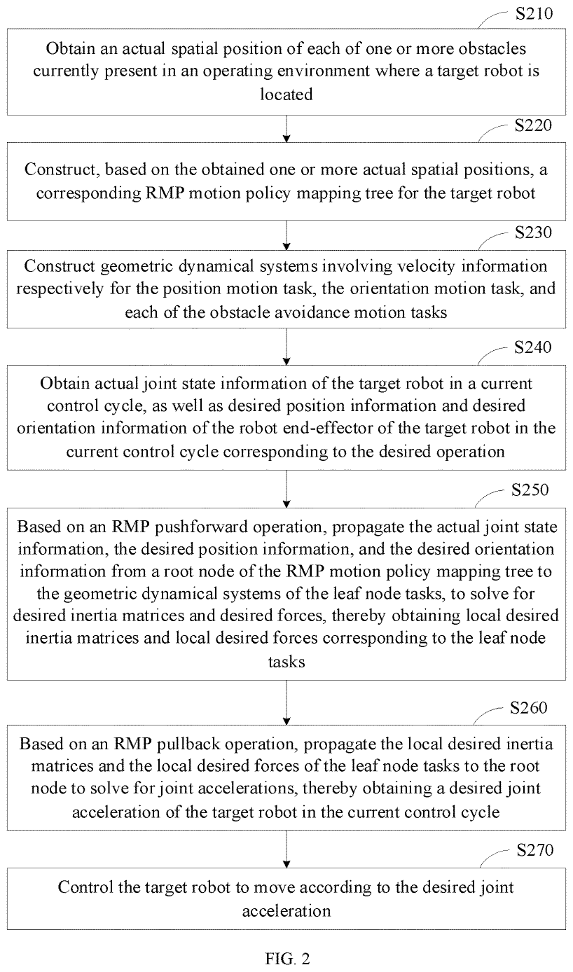

In one embodiment, a robot control device 10 may include a storage 11, a processor 12, a communication unit 13 and a robot obstacle avoidance control module 100. The storage 11, the processor 12 and the communication unit 13 are directly or indirectly electrically connected to one another to enable data transmission or interaction. For example, they can be electrically connected to each another through one or more communication buses or signal lines. The processor 12 performs corresponding operations by executing the executable computer programs stored in the storage 11. When the processor 12 executes the computer programs, the steps in the embodiments of a robot obstacle avoidance control method, such as steps S210 to S270 in FIG. 2 are implemented.

The processor 12 may be an integrated circuit chip with signal processing capability. The processor 12 may be a central processing unit (CPU), a graphics processing unit (GPU), a general-purpose processor, a network processor (NP), a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 12 can implement or execute the methods, steps, and logical blocks disclosed in the embodiments of the present disclosure.

The storage 11 may be, but not limited to, a random-access memory (RAM), a read only memory (ROM), a programmable read only memory (PROM), an erasable programmable read-only memory (EPROM), and an electrical erasable programmable read-only memory (EEPROM). The storage 11 may be an internal storage unit of the robot control device 10, such as a hard disk or a memory. The storage 11 may be an external storage device of the robot control device 10, such as a plug-in hard disk, a smart memory card (SMC), and a secure digital (SD) card, or any suitable flash cards. Furthermore, the storage 11 may include both an internal storage unit and an external storage device. The storage 11 is to store computer programs, other programs, and data required by the robot control device 10. The storage 11 can be used to temporarily store data that has been output or is about to be output. Upon receiving an execution instruction, the processor 12 can correspondingly execute the computer program stored on the storage 11.

Exemplarily, the one or more computer programs may be divided into one or more modules/units, and the one or more modules/units are stored in the storage 11 and executable by the processor 12. The one or more modules/units may be a series of computer program instruction segments capable of performing specific functions, and the instruction segments are used to describe the execution process of the one or more computer programs in the robot control device 10.

In one embodiment, the communication unit 13 is to establish, through a network, a communication connection between the robot control device 10 and other electronic devices, and to transmit and receive data through the network. The network includes a wired communication network and a wireless communication network. For example, the robot control device 10 may acquire, through the communication unit 13, motion trajectory information of a desired task to be performed by the end effector of the target robot from a task planning device. The motion trajectory information may include desired position information, desired posture information, and the like respectively corresponding to different control cycles of the end effector during execution of the desired task. The robot control device 10 may further transmit joint control instructions to the target robot through the communication unit 13, so as to drive the target robot to move according to the received joint control instructions.

In one embodiment, the robot obstacle avoidance control module 100 may include at least one software functional module stored in the storage 11 in the form of software or firmware, or integrated into the operating system of the robot control device 10. The processor 12 may be configured to execute executable modules stored in the storage 11, such as the software functional modules and computer programs included in the robot obstacle avoidance control module 100. Through the robot obstacle avoidance control module 100, the robot control device 10 can utilize the rapid iterative solving characteristics of RMP and the velocity continuity characteristics of a geometric dynamical system involving velocity information, thereby ensuring that the robot achieves reactive obstacle avoidance with respect to dynamic obstacles while performing a desired task, improving the real-time performance and maneuverability of robot obstacle avoidance, and enabling the robot to avoid dynamic obstacles with high agility and high responsiveness while still achieving the desired task execution effect.

It should be noted that the block diagram shown in FIG. 1 is only an example of the robot control device 10. The robot control device 10 may include more or fewer components than what is shown in FIG. 1, or have a different configuration than what is shown in FIG. 1. For example, the processor 12 may be electrically connected to a controller 14, and the controller 14 may be electrically connected to a motor 15. The controller 14 may receive instructions from the processor 12 and operate the motor 15 to change the motion of the target robot. Each component shown in FIG. 1 may be implemented in hardware, software, or a combination thereof.

In the present disclosure, in order to ensure that the robot control device 10 can utilize the rapid iterative solving characteristics of RMP and the velocity continuity characteristics of a geometric dynamical system involving velocity information, thereby enabling the robot to achieve reactive obstacle avoidance with respect to dynamic obstacles while performing a desired task, improving the real-time performance and maneuverability of robot obstacle avoidance, and enabling the robot to avoid dynamic obstacles with high agility and high responsiveness while still achieving the desired task execution effect, embodiments of the present disclosure provide a robot obstacle avoidance control method to achieve the foregoing objectives. The robot obstacle avoidance control method will be described in detail below.

Referring to FIG. 2, in one embodiment, the robot obstacle avoidance control method is implemented by the above-described robot control device 10, and the robot obstacle avoidance control method may include steps S210 to S270.

Step S210: Obtain an actual spatial position of each of one or more obstacles currently present in an operating environment where a target robot is located.

Specifically, at least one obstacle detection device may be installed within the operating environment where the target robot is located, so as to detect which obstacles currently exist in the operating environment and the actual spatial positions of the respective obstacles in the operating environment at the current time. Thereafter, the at least one obstacle detection device may transmit the detected actual spatial positions of all obstacles in the operating environment where the robot control device 10 is located, such that the robot control device 10 can intuitively determine changes in the number of obstacles and changes in obstacle positions within the operating environment where the target robot is located. The aforementioned obstacle detection device may include, but is not limited to, a LiDAR device, a camera, an ultrasonic radar device, or the like. The obstacle detection device may be mounted on the target robot, arranged around the target robot, or correspondingly disposed on the robot control device 10 when the robot control device 10 is located within the operating environment. The specific quantity and/or arrangement manner of the obstacle detection devices may be configured differently according to monitoring requirements of the robot operating environment, and the present disclosure is not limited thereto.

Step S220: Construct, based on the obtained one or more actual spatial positions, a corresponding Riemannian motion policy (RMP) motion policy mapping tree for the target robot.

In one embodiment, a root node task of the RMP motion policy mapping tree corresponds to a robot joint space. A number of leaf node tasks of the RMP motion policy mapping tree include a position motion task and an orientation motion task for the robot end-effector to perform a desired operation, as well as obstacle avoidance motion tasks in which a number of robot key parts including the robot end-effector perform obstacle avoidance with respect to each obstacle. The position motion task is to characterize a motion task in which the robot end-effector of the target robot performs a desired operation in a positional dimension. The orientation motion task is to characterize a motion task in which the robot end-effector of the target robot performs the desired operation in an orientation dimension. The obstacle avoidance motion tasks are to characterize motion tasks in which key parts of the target robot avoid existing obstacles within the operating environment.

For a Riemannian motion policy (RMP), its essence is a motion policy with geometric information described by a second-order differential equation in a Riemannian manifold space. The canonical form of an RMP may be expressed as (a,M)^{M}, and the natural form of the RMP may be expressed as [f,M]^{M}. Herein, M represents an m-dimensional Riemannian manifold space whose spatial coordinates belong to P^{m,μ}, a:P^{m}×P^{m}→P^{m} represents a second-order continuous motion policy, M:P^{m}×P^{m}→P^{m×m} represents a differential mapping, and f=Ma. When the RMP is applied to robot dynamics, a may be regarded as a desired acceleration, M may be regarded as a desired inertia matrix, and f may be regarded as a desired force.

Therefore, after obtaining the actual spatial positions of all obstacles currently existing in the operating environment, the robot control device 10 may decompose the robot motion task, according to the RMP framework, into a number of motion policies distributed in Riemannian spaces of different dimensions, such as a robot joint space and a robot task space. The decomposed motion policy in the robot joint space may directly serve as a root node task of an RMP motion policy mapping tree, and the decomposed motion policies in the robot task space may directly serve as leaf node tasks of the RMP motion policy mapping tree. At this time, the root node task of the RMP motion policy mapping tree is essentially used to characterize a global motion task (i.e., global motion policy) corresponding to the desired effect of the robot motion task to be achieved by the target robot in the robot joint space, while the leaf node tasks of the RMP motion policy mapping tree are used to characterize the local motion tasks (i.e., local motion policies) corresponding to the branch subtasks of the robot motion task to be achieved by the target robot in the robot task space. Accordingly, the robot control device 10 may decompose the robot motion task by taking “driving the target robot to perform a desired task while ensuring that each key part of the target robot avoids each obstacle in the current operating environment” as the robot motion task, thereby obtaining an RMP motion policy mapping tree. The RMP motion policy mapping tree includes: a root node task, i.e., “a global motion task in the robot joint space,” and multiple leaf node tasks, i.e., “a position motion task for the robot end-effector to perform the desired operation in the robot task space,” “an orientation change task for the robot end-effector to perform the desired operation in the robot task space,” “an obstacle avoidance motion task for the robot end-effector to avoid various obstacles in the robot task space,” and “an obstacle avoidance motion task for each robot key part other than the robot end-effector to avoid various obstacles in the robot task space.”

In one implementation, the robot control device 10 may directly use the root-node task “a position motion task for the robot end-effector to perform a desired task in the robot task space” as a parent node for each leaf node task to construct the RMP motion policy mapping tree, such that a spatial transformation relationship between the robot joint space corresponding to the root node task and the robot task space corresponding to each leaf node task serves as a connecting edge between the root node and the corresponding leaf node.

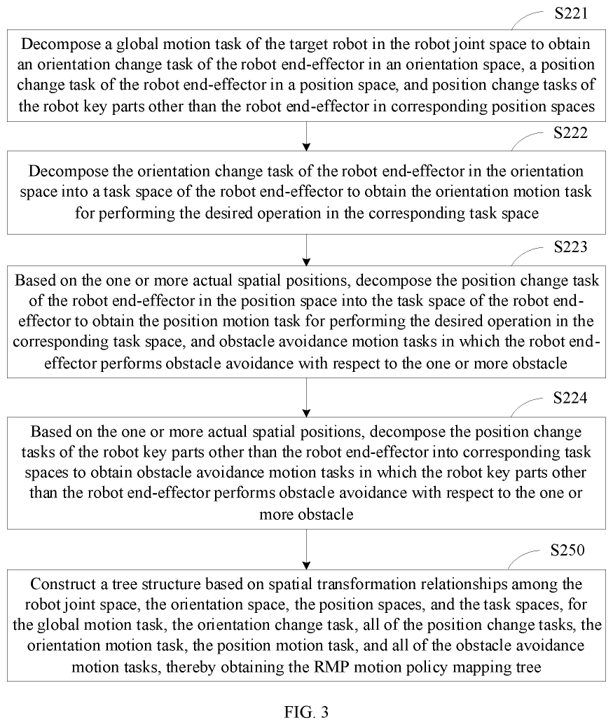

Referring to FIG. 3, which is a schematic flowchart illustrating substeps included in step S220 of FIG. 2, in one embodiment, in order to ensure that the various local motion policies involved in the RMP motion policy mapping tree constructed in the present disclosure can be more easily migrated for use on another robot, an intermediate stem node serving as a transitional node may be introduced between the root node and each leaf node. The stem node is configured to be related only to the robot kinematic model and does not require any motion policy to be actively assigned thereto, thereby decoupling the body-specific association between the local motion policies corresponding to the leaf nodes and the target robot. Accordingly, after a leaf node has been established, the local motion policy corresponding to the leaf node can be more easily migrated for use on another robot simply by replacing the stem node task connected thereto. In this case, step S220 may include substeps S221 to S225, so as to construct an RMP motion policy mapping tree involving desired-task execution and obstacle avoidance motion, while providing strong motion policy portability.

Substep S221: Decompose a global motion task of the target robot in the robot joint space to obtain an orientation change task of the robot end-effector in an orientation space, a position change task of the robot end-effector in a position space, and position change tasks of the robot key parts other than the robot end-effector in corresponding position spaces.

In one embodiment, ((q,\dot{q}),[fᵣ,Mᵣ]^{C}) may be used to represent a global motion task of the target robot in the robot joint space C, where (q,\dot{q}) is used to represent state parameters (joint positions and joint velocities) involved in the global motion task, and [fᵣ,Mᵣ]^{C} is used to represent an RMP natural form corresponding to the global motion task. (x₀,\dot{x}₀),[fₜ_{₀},Mₜ_{₀}]^{x}^{₀}) may be used to represent an orientation change task of the robot end-effector in an orientation space x₀, where (x₀,\dot{x}₀) is used to represent state parameters (orientation information and orientation change velocity) involved in the orientation change task, and [fₜ_{₀},Mₜ_{₀}]^{x}^{₀} is used to represent an RMP natural form corresponding to the orientation change task, x₀⊆SO(3). ((x₁,\dot{x}₁),[fₜ_{₁},Mₜ_{₂}]^{x}^{₁}) may be used to represent a position change task of the robot end-effector in a position space x₁, where (x₁,\dot{x}₁) is used to represent state parameters (position information and position change velocity) involved in the position change task, and [fₜ,Mₜ_{₁}]^{x}^{₁} is used to represent an RMP natural form corresponding to the position change task,

$${x}_{1} ⊆ {R}^{3} \cdot {\{ ( ( {x}_{i} , {\dot{x}}_{i} ) , {[ {f}_{{t}_{i}} , {M}_{{t}_{i}} ]}^{{x}_{i}} ) \}}_{i = 2}^{l}$$

may be used to represent (1-1) position change tasks of robot key parts other than the robot end-effector in corresponding position spaces xᵢ|(i=2, . . . , l), where (xᵢ,\dot{x}ᵢ)|(i=2, . . . , l) is used to represent state parameters (position information and position change velocity) involved in the position change task of the i-th robot key part, and [fₜ_{ᵢ},Mₜ_{ᵢ}]^{x}^{ᵢ}|(i=2, . . . , l) is used to represent an RMP natural form corresponding to the position change task of the i-th robot key part, xᵢ ⊆R³|(i=2, . . . , l). At this time, the foregoing global motion task may be regarded as a common parent node of the above orientation change task and all position change tasks.

Substep S222: Decompose the orientation change task of the robot end-effector in the orientation space into a task space of the robot end-effector to obtain the orientation motion task for performing the desired operation in the corresponding task space.

In one embodiment, (x₀,\dot{x}₀),[f_{g}_{ₒ},M_{g}_{ₒ}]^{R}^{₀}) may be used to represent an orientation motion task of the robot end-effector performing a desired operation in a task space R₀, where (x₀,\dot{x}₀) is used to represent state parameters (orientation information and orientation change velocity) involved in the orientation motion task, and [f_{g}_{ₒ},M_{g}_{ₒ}]^{R}^{₀} is used to represent an RMP natural form corresponding to the orientation motion task, R₀⊆SO(3). In this case, the foregoing orientation change task may be regarded as a parent node of the orientation motion task.

Substep S223: Based on the one or more actual spatial positions, decompose the position change task of the robot end-effector in the position space into the task space of the robot end-effector to obtain the position motion task for performing the desired operation in the corresponding task space, and obstacle avoidance motion tasks in which the robot end-effector performs obstacle avoidance with respect to the one or more obstacles.

In one embodiment, the position change task of the robot end-effector in the position space x₁ may be decomposed into a task space R₁ having the same dimensionality as the position space x₁, thereby obtaining a position motion task for the robot end-effector to perform a desired operation in the task space R₁. At this time, the position motion task may be represented by (x₁,\dot{x}₁),[f_{g}_{ₚ},M_{g}_{ₚ}]^{R}^{₁}), where (x₁,\dot{x}₁) is used to represent state parameters (position information and position change velocity) involved in the position motion task, and [f_{g}_{ₚ},M_{g}_{ₚ}]^{R}^{₁} is used to represent an RMP natural form corresponding to the position motion task, R₁⊆R³. In this case, the foregoing position change task may be regarded as a parent node of the position motion task.

Meanwhile, the position change task of the robot end-effector in position space x₁ can be decomposed into a one-dimensional manifold task space Dⱼ|(j=1, . . . ,n) corresponding to each obstacle, which describes the change in relative distance between the robot end-effector and the respective obstacle. This obtains the obstacle avoidance motion task for the robot end-effector in the task space Dⱼ|(j=1, . . . , n) corresponding to the j-th obstacle. At this time, the obstacle avoidance motion task in which the robot end-effector avoids the j-th obstacle in the task space Dⱼ|(j=2, . . . , n) corresponding to the j-th obstacle may be represented by

$$( ( {s}_{j}^{1} , {\dot{s}}_{j}^{1} ) , {[ {f}_{{a}_{j}^{1}} , {M}_{{a}_{j}^{1}} ]}^{{D}_{j}} ) ,$$

where

$$( {s}_{j}^{1} , {\dot{s}}_{j}^{1} )$$

is used to represent state parameters involved in the obstacle avoidance motion task, including a relative distance between the robot end-effector and the j-th obstacle and a relative motion velocity between the robot end-effector and the j-th obstacle, and

$${[ {f}_{{a}_{j}^{1}} , {M}_{{a}_{j}^{1}} ]}^{{D}_{j}}$$

is used to represent an RMP natural form corresponding to obstacle, and is used to represent an RMP natural form corresponding to the obstacle avoidance motion task. Here, n is used to represent the total number of obstacles in the operating environment. In this case, the foregoing position change task may be regarded as a parent node of the obstacle avoidance motion task. The relative distance and the relative motion velocity between the robot end-effector and the j-th obstacle may both be determined based on the actual spatial position of the j-th obstacle.

Substep S224: Based on the one or more actual spatial positions, decompose the position change tasks of the robot key parts other than the robot end-effector into corresponding task spaces to obtain obstacle avoidance motion tasks in which the robot key parts other than the robot end-effector perform obstacle avoidance with respect to the one or more obstacles.

In one embodiment, for each robot key part other than the robot end-effector, the position change task of the robot key part in the corresponding position spaces xᵢ| (i=2, . . . , l) may be decomposed into a one-dimensional manifold task space Dⱼ|(j=1, . . . , n) corresponding to each obstacle and describing a relative distance change condition between the corresponding robot key part and the corresponding obstacle, thereby obtaining an obstacle avoidance motion task in which the i-th (i=2, . . . , 1) robot key portion avoids the j-th obstacle in the task space Dⱼ|(j=1, . . . , n). At this time, the obstacle avoidance motion task in which the i-th robot key part avoids the j-th obstacle in the task space Dⱼ|(j=2, . . . , n) corresponding to the j-th obstacle may be represented by

$$( ( {s}_{j}^{i} , {\dot{s}}_{j}^{i} ) , {[ {f}_{{a}_{j}^{i}} , {M}_{{a}_{j}^{i}} ]}^{{D}_{j}} ) ,$$

where

$$( {s}_{j}^{i} , {\dot{s}}_{j}^{i} )$$

is used to represent state be represented by where parameters involved in the obstacle avoidance motion task, including a relative distance between the i-th robot key part and the j-th obstacle and a relative motion velocity between the i-th robot key portion and the j-th obstacle, and

$${[ {f}_{{a}_{j}^{i}} , {M}_{{a}_{j}^{i}} ]}^{{D}_{j}}$$

is used to represent an RMP natural form corresponding to the obstacle avoidance motion task. In this case, the foregoing position change task may be regarded as a parent node of the obstacle avoidance motion task. The relative distance and the relative motion velocity between the i-th robot key part and the j-th obstacle may both be determined based on the actual spatial position of the j-th obstacle.

Substep S225: Construct a tree structure based on spatial transformation relationships among the robot joint space, the orientation space, the position spaces, and the task spaces, for the global motion task, the orientation change task, all of the position change tasks, the orientation motion task, the position motion task, and all of the obstacle avoidance motion tasks, thereby obtaining the RMP motion policy mapping tree.

The spatial transformation relationships among the robot joint space, the orientation space, the position space, and the task spaces may include: a spatial transformation relationship between the robot joint space C and the orientation space x₀; a spatial transformation relationship between the robot joint space C and the position spaces xᵢ|(i=1, . . . , l); a spatial transformation relationship between the orientation space x₀ and the task space R₀; a spatial transformation relationship between the position space x₁ and the task space R₁; and a spatial transformation relationship between the position spaces xᵢ|(i=1, . . . , l) and the task spaces Dⱼ|(j=1, . . . , n).

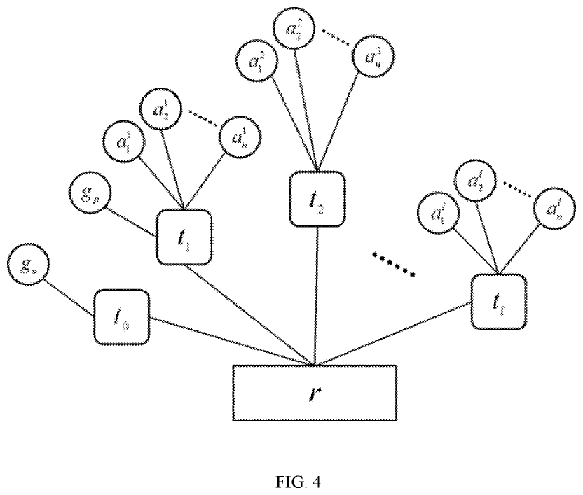

At this time, taking the schematic tree structure of the RMP motion policy mapping tree shown in FIG. 4 as an example, the global motion task may serve as a root node r; the orientation change task may serve as a stem node t₀ (i.e., a child node of the root node r); the position change task of the robot end-effector may serve as a stem node t₁; the position change tasks of the respective robot key parts other than the robot end-effector may respectively serve as stem nodes tᵢ|(i=2, . . . , l); the orientation motion task of the robot end-effector may serve as a leaf node gₒ of the stem node t₀, i.e., a child node of the stem node t₀; the position motion task of the robot end-effector may serve as a leaf node gₚ of the stem node t₁; the obstacle avoidance motion task corresponding to the j-th (j=1, . . . , n) obstacle for the robot end-effector may serve as a leaf node

$${a}_{j}^{1}$$

of the stem node t₁; and the obstacle avoidance motion task corresponding to the j-th (j=1, . . . , n) obstacle for the i-th robot key part other than the robot end-effector may serve as a leaf node

$${a}_{j}^{i}$$

of the stem node tᵢ corresponding to the i-th robot key part.

Accordingly, by executing the above-described substeps S221 to S225, the robot control device can construct an RMP motion policy mapping tree involving desired-task execution and obstacle avoidance motion, while providing strong motion policy portability.

Step S230: Construct geometric dynamical systems involving velocity information respectively for the position motion task, the orientation motion task, and each of the obstacle avoidance motion tasks.

In one embodiment, a geometric dynamical system may be regarded as a virtual mechanical system defined on a manifold space. The system inertia of the virtual mechanical system is jointly determined by the configuration and velocity of the mechanical body. A single geometric dynamical system may be represented by a mathematical tuple (M, G, B, Φ), where M is used to represent a manifold space (for example, task space R₀, task space R₁, and task spaces Dⱼ| (j=1, . . . ,n)) in which the corresponding geometric dynamical system is located. In this case, the geometric dynamical system is required to satisfy the following equations:

$$\{ \begin{matrix}( G ( x , \dot{x} ) + {Ξ}_{G} ( x , \dot{x} ) ) \ddot{x} + {ξ}_{G} ( x , \dot{x} ) = − {∇}_{x} Φ ( x ) − B ( x , \dot{x} ) \dot{x} \\ {Ξ}_{G} ( x , \dot{x} ) = \frac{1}{2} {\sum }_{i = 1}^{m} {\dot{x}}_{i} {\partial }_{\dot{x}} {g}_{i} ( x , \dot{x} ) \\ {ξ}_{G} ( x , \dot{x} ) = {G}^{x} ( x , \dot{x} ) \dot{x} − \frac{1}{2} {∇}_{x} ( {\dot{x}}^{T} G ( x , \dot{x} ) \dot{x} ) \\ {G}^{x} ( x , \dot{x} ) = {[ {\partial }_{x} {g}_{i} ( x , \dot{x} ) \dot{x} ]}_{i = 1}^{m}\end{matrix} ,$$

where G(x,\dot{x}) is used to represent a geometric metric matrix corresponding to the system state parameters (x,\dot{x}) of the corresponding geometric dynamical system; B(x,\dot{x}) is used to represent a damping matrix corresponding to the system state parameters (x,\dot{x}) of the corresponding geometric dynamical system; Φ(x) is used to represent a potential energy equation corresponding to the geometric dynamical system; [symbol] _{G}(x,\dot{x}) is used to represent a first curvature term matrix corresponding to the system state parameters (x,\dot{x}) of the corresponding geometric dynamical system; ξ_{G}(x,\dot{x}) is used to represent a second curvature term matrix corresponding to the system state parameters (x,\dot{x}) of the corresponding geometric dynamical system; gᵢ(x,\dot{x}) is used to represent a submatrix in the i-th column of G(x,\dot{x}); ∂ₓ is used to represent a partial derivative with respect to the state parameter x; ∂_{\dot{x}} is used to represent a partial derivative with respect to the state parameter \dot{x}; ∇ₓ is used to represent a gradient with respect to the state parameter x; m is used to represent the total number of matrix columns of G(x,*); the state parameter \dot{x} is a differential of the state parameter x; and the state parameter \ddot{x} is a differential of the state parameter \dot{x}.

In this case, the state parameter x and the state parameter \dot{x} corresponding to the position motion task are respectively used to represent position information and position change velocity information of the robot end-effector. The state parameter x and the state parameter \dot{x} corresponding to the orientation motion task are respectively used to represent orientation information and orientation change velocity information of the robot end-effector. The state parameter x and the state parameter \dot{x} corresponding to the obstacle avoidance motion task are respectively used to represent relative distance information and relative motion velocity information between one of the robot key parts, including the robot end-effector, and a corresponding obstacle.

It should be understood that the geometric dynamical systems respectively corresponding to the above-described position motion task, orientation motion task, and various obstacle avoidance motion tasks may be designed according to robot motion requirements, such as maintaining balance, maintaining a favorable configuration, smoothly avoiding obstacle collisions, smoothly reaching a desired position, smoothly reaching a desired orientation, abruptly reaching a desired position, abruptly reaching a desired orientation, suddenly stopping to avoid obstacle collisions, and the like. The present disclosure imposes no limitation on the specific design approach of the geometric dynamical systems.

In one implementation, based on a robot motion requirement of smoothly reaching a desired orientation, the geometric dynamical system corresponding to the orientation motion task may be designed as GDS(R₀, G_{g}_{ₒ}, B_{g}_{ₒ}, φ_{g}_{ₒ}), where R₀ is used to represent that the manifold space in which the orientation motion task is located is the task space in which the leaf node gₒ is located. The calculation equations for G_{g}_{ₒ},

$${B}_{{g}_{o}} , and {Φ}_{{g}_{o}} are as follows : \{ \begin{matrix}{G}_{{g}_{o}} = {w}^{o} I , {B}_{{g}_{o}} = {r}_{d} {w}^{o} \\ {w}^{o} = ( {w}_{u}^{o} − {w}_{l}^{o} ) \times exp ( \frac{− {‖ e ‖}^{2}}{( 2 {σ}^{2} )} ) + {w}_{l}^{o} \\ {∇}_{e} {Φ}_{{g}_{o}} = {r}_{p} \times \frac{1 − exp ( − 2 α ‖e ‖ )}{1 + exp ( − 2 α ‖ e ‖ )} \times {w}^{o} \hat{e} \\ e = {x}_{0} − {x}_{0}^{g} , \hat{e} = \frac{e}{‖ e ‖}\end{matrix} ,$$

where G_{g}_{ₒ} is used to represent a geometric metric matrix of the geometric dynamical system GDS(R₀,G_{g}_{ₒ},B_{g}_{ₒ},Φ_{g}_{ₒ}); x is used to represent an identity matrix having the same dimensionality as the robot joint space; w^{o} is used to represent a metric coefficient of the geometric dynamical system GDS(R₀,G_{g}_{ₒ},B_{g}_{ₒ},Φ_{g}_{ₒ}); B_{g}_{ₒ} is used to represent a damping matrix of the geometric dynamical system GDS(R₀,G_{g}_{ₒ},B_{g}_{ₒ},Φ_{g}_{ₒ}); Φ_{g}_{ₒ} is used to represent a potential energy equation of the geometric dynamical system GDS(R₀,G_{g}_{ₒ},B_{g}_{ₒ},Φ_{g}_{ₒ});

$${x}_{0}^{g}$$

is used to represent a desired orientation of the robot end-effector; x₀ is used to represent an actual orientation of the robot end-effector; e is used to represent a vector difference between the actual orientation and the desired orientation of the robot end-effector; ∥e∥ is used to represent a norm of the vector e; ∇ₑ is used to represent taking a gradient with respect to the vector

$$e ; {w}_{u}^{o}$$

is used to represent an upper limit value of the metric coefficient w^{o};

$${w}_{l}^{o}$$

is used to represent a lower limit value of the metric coefficient w^{o}; rₚ is used to represent a proportional gain; r_{d} is used to represent a velocity gain; σ is used to represent a scale parameter; and α is used to represent a smoothness parameter.

In one embodiment, based on a robot motion requirement of smoothly reaching a desired position, the geometric dynamical system corresponding to the position motion task may be designed as GDS(R₁,G_{g}_{ₚ},B_{g}_{ₚ},Φ_{g}_{ₚ}), where R₁ is used to represent that the manifold space in which the position motion task is located is the task space in which the leaf node gₚ is located. The calculation equations for G_{g}_{ₚ}, B_{g}_{ₚ},

$$and {Φ}_{{g}_{p}} are as follows : \{ \begin{matrix}{G}_{{g}_{p}} = {w}^{p} I , {B}_{{g}_{p}} = {r}_{d} {w}^{p} \\ {w}^{p} = ( {w}_{u}^{p} − {w}_{l}^{p} ) \times exp ( \frac{− {‖ d ‖}^{2}}{( 2 {σ}^{2} )} ) + {w}_{l}^{p} \\ {∇}_{d} {Φ}_{{g}_{p}} = {r}_{p} \times \frac{1 − exp ( − 2 α ‖ d ‖ )}{1 + exp ( − 2 α ‖ d ‖ )} \times {w}^{p} \hat{d} \\ d = {x}_{1} − {x}_{1}^{p} , \hat{d} = \frac{d}{‖ d ‖}\end{matrix} ,$$

where G_{g}_{ₚ} is used to represent a geometric metric matrix of the geometric dynamical system GDS(R₁,G_{g}_{ₚ},B_{g}_{ₚ},Φ_{g}_{ₚ}); I is used to represent an identity matrix having the same dimensionality as the robot joint space; w^{p} is used to represent a metric coefficient of the geometric dynamical system GDS(R₁,G_{g}_{ₚ},B_{g}_{ₚ},P_{g}_{ₚ}); B_{g}_{ₚ} is used to represent a damping matrix of the geometric dynamical system GDS(R₁,G_{g}_{ₚ},B_{g}_{ₚ},P_{g}_{ₚ}); Φ_{g}_{ₚ} is used to represent a potential energy equation of the geometric dynamical system GDS(R₁,G_{g}_{ₚ},B_{g}_{ₚ},Φ_{g}_{ₚ});

$${x}_{1}^{p}$$

is used to represent a desired position of the robot end-effector; x₁ is used to represent an actual position of the robot end-effector; d is used to represent a vector difference between the actual position and the desired position of the robot end-effector; ∥d∥ is used to represent a norm of the vector d; ∇_{d} is used to represent a gradient with respect to the vector

$$d ; {w}_{u}^{p}$$

is used to represent an upper limit value of the metric coefficient w^{p};

$${w}_{l}^{p}$$

is used to represent a lower limit value of the metric coefficient w^{p}; rₚ is used to represent a proportional gain; r_{d} is used to represent a velocity gain; σ is used to represent a scale parameter; and α is used to represent a smoothness parameter.

In one embodiment, based on a robot motion requirement of smoothly avoiding obstacle collisions, the geometric dynamical system corresponding to the obstacle avoidance motion task of the i-th (i=1, . . . , 1) robot key part with respect to the j-th (j=1, . . . , n) obstacle may be designed as

$$GDS ( {D}_{j} , {G}_{{a}_{j}^{i}} , {B}_{{a}_{j}^{i}} , {Φ}_{{a}_{j}^{i}} ) ,$$

where Dⱼ is used to represent that the manifold space in which the obstacle avoidance motion task is located is the task space in which the leaf node

$${a}_{j}^{i}$$

is located. The calculation equations for

$${G}_{{a}_{j}^{i}}$$

,

$${B}_{{a}_{j}^{i}}$$

, and

$${Φ}_{{a}_{j}^{i}}$$

are as follows:

$$\{ \begin{matrix}{G}_{{a}_{j}^{i}} = w ( {s}_{j}^{i} ) \times u ( {\dot{s}}_{j}^{i} ) , {B}_{{a}_{j}^{i}} = {r}_{d} {G}_{{a}_{j}^{i}} \\ {∇}_{{s}_{j}^{i}} {Φ}_{{a}_{j}^{i}} = {r}_{p} \times w ( {s}_{j}^{i} ) \times {∇}_{{s}_{j}^{i}} w ( {s}_{j}^{i} ) \\ w ( {s}_{j}^{i} ) = \frac{max ( {s}_{u} - {s}_{j}^{i} , 0 )}{max ( {s}_{j}^{i} - {s}_{l} , ε )} \\ u ( {\dot{s}}_{j}^{i} ) = \{ \begin{matrix}1 - exp ( \frac{- {( {\dot{s}}_{j}^{i} )}^{2}}{( 2 {σ}^{2} )} ) & {\dot{s}}_{j}^{i} < 0 \\ 0 & {\dot{s}}_{j}^{i} \geq 0\end{matrix}\end{matrix} ,$$

where

$${G}_{{a}_{j}^{i}}$$

is used to represent a geometric metric matrix of the geometric dynamical system

$$G D S ( {D}_{j} , {G}_{{a}_{j}^{i}} , {B}_{{a}_{j}^{i}} , {Φ}_{{a}_{j}^{i}} ) ; {B}_{{a}_{j}^{i}}$$

is used to represent a damping matrix of the geometric dynamical system

$$G D S ( {D}_{j} , {G}_{{a}_{j}^{i}} , {B}_{{a}_{j}^{i}} , {Φ}_{{a}_{j}^{i}} ) ; {Φ}_{{a}_{j}^{i}}$$

is used to represent a potential energy equation of the geometric dynamical system

$$G D S ( {D}_{j} , {G}_{{a}_{j}^{i}} , {B}_{{a}_{j}^{i}} , {Φ}_{{a}_{j}^{i}} ) ; {s}_{j}^{i}$$

is used to represent a relative distance between the i-th robot key part and the j-th obstacle;

$${\dot{s}}_{j}^{i}$$

is used to represent a relative motion velocity between the i-th robot key part and the j-th obstacle;

$${∇}_{{s}_{j}^{i}}$$

is used to represent a gradient with respect to the state parameter

$${s}_{j}^{i} ; {s}_{u}$$

is used to represent a maximum safety distance; sₗ is used to represent a minimum safety distance; rₚ is used to represent a proportional gain; r_{d} is used to represent a velocity gain; σ is used to represent a scale parameter; and ε is a positive number having a relatively small value.

Step S240: Obtain actual joint state information of the target robot in a current control cycle, as well as desired position information and desired orientation information of the robot end-effector of the target robot in the current control cycle corresponding to the desired operation.

The actual joint state information includes actual joint positions and actual joint velocities of the target robot. The actual joint state information may be directly read by the robot control device 10 from the target robot. The desired position information and the desired orientation information may be read by the robot control device 10 from the target robot, or may be obtained by the robot control device 10 from a task planning device. The present disclosure imposes no limitation on the specific manner in which the robot control device 10 acquires the desired position information and the desired orientation information.

Step S250: Based on an RMP pushforward operation, propagate the actual joint state information, the desired position information, and the desired orientation information from a root node of the RMP motion policy mapping tree to the geometric dynamical systems of the leaf node tasks, to solve for desired inertia matrices and desired forces, thereby obtaining local desired inertia matrices and local desired forces corresponding to the leaf node tasks.

In one embodiment, for the RMP framework, an RMP pushforward operation is essentially a forward propagation operation that propagates state information flows from a parent node toward child nodes. When there exists a parent node u=((x,\dot{x}),[f,M]^{M}) and K child nodes

$${\{ {v}_{i} = ( ( {y}_{i} , {\dot{y}}_{i} ) , {[ {f}_{i} , {M}_{i} ]}^{{N}_{i}} ) \}}_{i = 1}^{K}$$

under the parent node, and a spatial transformation relationship Nᵢ=ψₑ_{ᵢ}(M) exists between the parent node and the i-th child node, the foregoing RMP pushforward operation may be expressed as: (yᵢ,\dot{y}ᵢ)=pushforward(x,\dot{x})=(ψₑ_{ᵢ}(x),Jᵢ(x)\dot{x}), where Jᵢ=∂ₓψₑ_{ᵢ} and ∂ₓ is used to represent a partial derivative with respect to the state parameter x.

Accordingly, the robot control device 10 may, based on the spatial transformation relationships between the root node and the respective leaf nodes disclosed by the RMP motion policy mapping tree, which includes the spatial transformation relationships between the root node and the respective stem nodes shown in FIG. 4, as well as the spatial transformation relationships between each stem node and its corresponding at least one leaf node, propagate the above-described actual joint state information, desired position information, and desired orientation information to the geometric dynamical systems of the respective leaf nodes through an RMP pushforward operation. Thereafter, desired inertia matrix solving and desired force solving may be performed for the geometric dynamical system of each leaf node, so as to obtain, for each leaf node, a local desired inertia matrix and a local desired force required for implementing the corresponding branch subtask under the effects of the above-described actual joint state information, desired position information, and desired orientation information.

The calculation equations for the local desired inertia matrix and the local desired force corresponding to each geometric dynamical system may be expressed as follows:

$$\{ \begin{matrix}M ( x , \dot{x} ) = G ( x , \dot{x} ) + {Ξ}_{G} ( x , \dot{x} ) \\ f ( x , \dot{x} ) = M ( x , \dot{x} ) \ddot{x} = - {∇}_{x} Φ ( x ) - B ( x , \dot{x} ) \dot{x} - {ξ}_{G} ( x , \dot{x} )\end{matrix} ,$$

where M(x,\dot{x}) is used to represent a local desired inertia matrix corresponding to the system state parameters (x,\dot{x}) of the corresponding geometric dynamical system, and f(x,\dot{x}) is used to represent a local desired force corresponding to the system state parameters (x,\dot{x}) of the corresponding geometric dynamical system.

Accordingly, the robot control device can accurately calculate the local desired inertia matrix and the local desired force of each leaf-node task included in the RMP motion policy mapping tree through the above calculation equations.

In one embodiment, when the geometric dynamical system corresponding to the orientation motion task is designed as the above-described GDS(R₀,G_{g}_{ₒ},B_{g}_{ₒ},Φ_{g}_{ₒ}), the actual calculation equations for the local desired inertia matrix M_{g}_{ₒ} and the local desired force f_{g}_{ₒ} corresponding to the orientation motion task are as follows:

$$\{ \begin{matrix}{M}_{{g}_{o}} = {G}_{{g}_{o}} \\ {ξ}_{{G}_{{g}_{o}}} = - \frac{1}{2} ( {‖ \dot{e} ‖}^{2} {∇}_{e} {w}^{o} - 2 \dot{e} {\dot{e}}^{T} {∇}_{e} {w}^{o} ) , \\ {f}_{{g}_{o}} = - {∇}_{e} {Φ}_{{g}_{o}} - {B}_{{g}_{o}} \dot{e} - {ξ}_{{G}_{{g}_{o}}}\end{matrix}$$

where ė is used to represent a vector change velocity between the actual orientation and the desired orientation of the robot end-effector, and ∥e∥ is used to represent a rate value of the vector change velocity ė.

In one embodiment, when the geometric dynamical system corresponding to the position motion task is designed as the above-described GDS(R₁,G_{g}_{ₚ},B_{g}_{ₚ},Φ_{g}_{ₚ}), the actual calculation equations for the local desired inertia matrix Mon and the local desired force f_{g}_{ₚ} corresponding to the position motion task are as follows:

$$\{ \begin{matrix}{M}_{{g}_{p}} = {G}_{{g}_{p}} \\ {ξ}_{{G}_{{g}_{p}}} = - \frac{1}{2} ( {‖ \dot{d} ‖}^{2} {∇}_{d} {w}^{p} - 2 \dot{d} {\dot{d}}^{T} {∇}_{d} {w}^{p} ) , \\ {f}_{{g}_{p}} = - {∇}_{d} {Φ}_{g p} - {B}_{{g}_{p}} \dot{d} - {ξ}_{{G}_{{g}_{p}}}\end{matrix}$$

where \dot{d} is used to represent a vector change velocity between the actual position and the desired position of the robot end-effector, and ∥\dot{d}∥ is used to represent a rate value of the vector change velocity \dot{d}.

In one embodiment, when the geometric dynamical system corresponding to the obstacle avoidance motion task of the i-th (i=1, . . . , 1) robot key part with respect to the j-th (j=1, . . . , n) obstacle is designed as the above-described

$$G D S ( {D}_{j} , {G}_{{a}_{j}^{i}} , {B}_{{a}_{j}^{i}} , {Φ}_{{a}_{j}^{i}} ) ,$$

the actual calculation equations for the local desired inertia matrix

$${M}_{{a}_{j}^{i}}$$

and the local desired force

$${f}_{{a}_{j}^{i}}$$

corresponding to the obstacle avoidance motion task are as follows:

$$\{ \begin{matrix}{M}_{{a}_{j}^{i}} = {G}_{{a}_{j}^{i}} + \frac{1}{2} {\dot{s}}_{j}^{i} w ( {s}_{j}^{i} ) \times {∇}_{{\dot{s}}_{j}^{i}} u ( {\dot{s}}_{j}^{i} ) \\ {ξ}_{{G}_{{a}_{j}^{i}}} = \frac{1}{2} {( {\dot{s}}_{j}^{i} )}^{2} u ( {\dot{s}}_{j}^{i} ) \times {∇}_{{s}_{j}^{i}} w ( {s}_{j}^{i} ) \\ {f}_{{a}_{j}^{i}} = - {∇}_{{s}_{j}^{i}} {Φ}_{{a}_{j}^{i}} - {B}_{{a}_{j}^{i}} {\dot{s}}_{j}^{i} - {ξ}_{{G}_{{a}_{j}^{i}}}\end{matrix} ,$$

where

$${∇}_{{\dot{s}}_{j}^{i}}$$

is used to represent a gradient with respect to the state parameter

$${\dot{s}}_{j}^{i} .$$

Step S260: Based on an RMP pullback operation, propagate the local desired inertia matrices and the local desired forces of the leaf node tasks to the root node to solve for joint accelerations, thereby obtaining a desired joint acceleration of the target robot in the current control cycle.

In one embodiment, for the RMP framework, an RMP pullback operation is essentially a reverse propagation operation that propagates RMP information flows from child nodes toward a parent node. When there exists a parent node u=((x,\dot{x}),[f,M]^{M}) and K child nodes

$${\{ {v}_{i} = ( ( {y}_{i} , \dot{{y}_{i}} ) , {[ {f}_{i} , {M}_{i} ]}^{{N}_{i}} ) \}}_{i = 1}^{K}$$

under the parent node, and a spatial transformation relationship Nᵢ=ψeᵢ(M) and Jᵢ=∂ₓψₑ_{ᵢ} exists between the parent node and the i-th child node, the foregoing RMP pullback operation may be expressed as:

$$\{ \begin{matrix}f = {\sum }_{i = 1}^{K} {J}_{i}^{T} ( {f}_{i} - {M}_{i} \dot{{J}_{i} \dot{x}} ) \\ M = {\sum }_{i = 1}^{K} {J}_{i}^{T} {M}_{i} {J}_{i}\end{matrix} ,$$

where Jᵢ is used to represent the differential of Jᵢ.

Accordingly, the robot control device 10 may, based on the spatial transformation relationships between the root node and the respective leaf nodes disclosed by the RMP motion policy mapping tree, which includes the spatial transformation relationships between the root node and each stem node shown in FIG. 4, as well as the spatial transformation relationships between each stem node and its corresponding at least one leaf node, propagate the local desired inertia matrices and local desired forces of the leaf-node tasks to the root node through an RMP pullback operation, thereby obtaining a global desired inertia matrix and a global desired force at the root node, which enable the root node to simultaneously achieve the task effects of all leaf-node tasks in the robot joint space. Thereafter, joint acceleration solving may be performed for the root node based on the obtained global desired inertia matrix and global desired force, thereby obtaining the desired joint acceleration corresponding to the global motion policy for implementing the robot motion task.

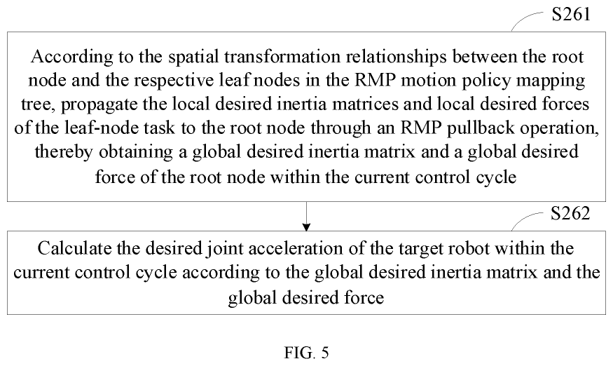

FIG. 5 is a schematic flowchart illustrating substeps included in step S260 of FIG. 2. In one embodiment, step S260 may include substeps S261 and S262, so as to rapidly integrate multiple local motion policies involving both dynamic obstacle avoidance functionality and desired task execution functionality into a single global motion policy. This ensures that the output of the global motion policy can achieve the motion effects of all local motion policies, while also ensuring real-time performance of the global policy output through the RMP propagation algorithm (including RMP pushforward and RMP pullback operations), thereby enabling the target robot to achieve reactive obstacle avoidance with respect to dynamic obstacles while performing the desired task.

Substep S261: According to the spatial transformation relationships between the root node and the respective leaf nodes in the RMP motion policy mapping tree, propagate the local desired inertia matrices and local desired forces of the leaf-node task to the root node through an RMP pullback operation, thereby obtaining a global desired inertia matrix and a global desired force of the root node within the current control cycle.

Substep S262: Calculate the desired joint acceleration of the target robot within the current control cycle according to the global desired inertia matrix and the global desired force.

In one embodiment, after obtaining the global desired inertia matrix and the global desired force corresponding to the root node, the robot control device 10 may calculate, based on a conversion relationship between the canonical form and the natural form of the RMP, a desired joint acceleration corresponding to the global motion policy of the target robot within the current control cycle by using the following equation: a=M⁺f, where M⁺=(M^{T}M)⁻¹M^{T}, a represents the desired joint acceleration, M⁺ represents a pseudoinverse matrix of the global desired inertia matrix M, and f represents the global desired force.

In another embodiment, in order to avoid a situation in which the calculated result of the desired joint acceleration becomes excessively large when the target robot moves near a singular configuration, thereby affecting the safety and reliability of the global motion policy solving process, the above-described substep S262 may include substeps A to C.

Substep A: Construct a desired acceleration constraint condition for the joint acceleration of the target robot based on a joint limit motion position interval and a joint acceleration regulation interval of the target robot.

The target acceleration constraint condition is expressed by the following equation:

$$max ( {\ddot{q}}_{l} , \frac{2}{Δ {t}^{2}} ( {q}_{l} - {q}^{*} - {\dot{q}}^{*} Δ t ) ) \leq \ddot{q} \leq min ( {\ddot{q}}_{u} , \frac{2}{Δ {t}^{2}} ( {q}_{u} - {q}^{*} - {\dot{q}}^{*} Δ t ) ) ,$$

where q* represents an actual joint position included in the actual joint state information; \dot{q}* represents an actual joint velocity included in the actual joint state information; Δt represents a cycle duration of a single control cycle; qᵤ represents an upper limit value of a joint position included in the joint limit motion position interval; \ddot{q}ᵤ represents a lower limit value of the joint position included in the joint limit motion position interval; \ddot{q}ᵤ represents an upper limit value of a joint acceleration included in the joint acceleration regulation interval; \ddot{q}ₗ represents a lower limit value of the joint acceleration included in the joint acceleration regulation interval; and \ddot{q} represents the joint acceleration of the target robot.

Substep B: Construct, based on the global desired inertia matrix and the global desired force, a corresponding acceleration error function for the joint acceleration of the target robot.

The acceleration error function is expressed by the following equation: (Mᵣ\ddot{q}−fᵣ)^{T}(Mᵣ\ddot{q}−fᵣ), where Mᵣ represents the global desired inertia matrix, and fᵣ represents the global desired force.

Substep C: Perform quadratic programming problem solving on the joint acceleration under an objective of minimizing an actual output magnitude of an acceleration error function, based on the target acceleration constraint condition, so as to obtain a desired joint acceleration of the target robot within the current control cycle. The quadratic programming problem expression for calculating the desired joint acceleration is expressed by the following equation:

$${( {M}_{r} \ddot{q} - {f}_{r} )}^{T} ( {M}_{r} \ddot{q} - {f}_{r} )$$

$$\begin{matrix}s . t . & max ( {\ddot{q}}_{l} , \frac{2}{Δ {t}^{2}} ( {q}_{l} - {q}^{*} - {\dot{q}}^{*} Δ t ) ) \leq \ddot{q} \leq min ( {\ddot{q}}_{u} , \frac{2}{Δ {t}^{2}} ( {q}_{u} - {q}^{*} - {\dot{q}}^{*} Δ t ) )\end{matrix} .$$

Accordingly, by executing the above-described substeps A to C, the robot control device can avoid a situation in which the calculated result of the desired joint acceleration becomes excessively large when the target robot moves near a singular configuration, thereby improving the safety and reliability of the global motion policy solving process.

Step S270: Control the target robot to move according to the desired joint acceleration.

In one embodiment, after obtaining the desired joint acceleration of the target robot corresponding to the global motion policy within the current control cycle, the robot control device 10 may calculate desired joint state information of the target robot within the current control cycle (including a desired joint position and a desired joint acceleration of the target robot within the current control cycle) based on the actual joint state information of the target robot within the current control cycle and the desired joint acceleration. Thereafter, the robot control device 10 controls the actual joint state information of the target robot in the robot joint space according to the obtained desired joint state information, so as to ensure that the target robot can achieve reactive obstacle avoidance with respect to dynamic obstacles while performing a desired task, thereby ensuring that the target robot can avoid dynamic obstacles with high agility and high responsiveness while still achieving the desired task execution effect.

Accordingly, by executing the above-described steps S220 to S270, the robot control device can utilize the rapid iterative solving characteristics corresponding to the RMP pushforward operation and the RMP pullback operation, thereby ensuring that the target robot achieves reactive obstacle avoidance with respect to dynamic obstacles while performing the desired task, and improving the real-time performance of robot obstacle avoidance. In addition, geometric dynamical systems involving velocity information are introduced during the RMP pushforward operation to perform local motion policy calculations, thereby utilizing the velocity continuity characteristics of the geometric dynamical systems to improve the maneuverability of robot obstacle avoidance, and ensuring that the target robot can avoid dynamic obstacles with high agility and high responsiveness while still achieving the desired task execution effect.

In the present disclosure, in order to ensure that the robot control device 10 can effectively execute the above-described robot obstacle avoidance control method, the foregoing functions are implemented by functionally partitioning the robot obstacle avoidance control module 100 stored in the robot control device 10 into different functional modules. The specific configuration of the robot obstacle avoidance control module 100 applied to the above-described robot control device 10 provided in the present application will be described below.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

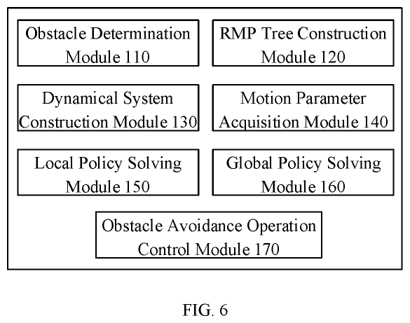

Corresponding to the method described in the foregoing embodiments, FIG. 6 illustrates a robot obstacle avoidance control module 100 according to one embodiment. The robot obstacle avoidance control module 100 may include an obstacle determination module 110, an RMP tree construction module 120, a dynamical system construction module 130, a motion parameter acquisition module 140, a local policy solving module 150, a global policy solving module 160, and an obstacle avoidance operation control module 170.

The obstacle determination module 110 is to obtain an actual spatial position of each of one or more obstacles currently present in an operating environment where a target robot is located. The RMP tree construction module 120 is to construct, based on the obtained one or more actual spatial positions, a corresponding Riemannian motion policy (RMP) motion policy mapping tree for the target robot. The root node task of the RMP motion policy mapping tree corresponds to a robot joint space, and a number of leaf node tasks of the RMP motion policy mapping tree include a position motion task and an orientation motion task for a desired operation of a robot end-effector, as well as obstacle avoidance motion tasks in which a number of robot key parts including the robot end-effector performs obstacle avoidance with respect to each of the one or more obstacles.

The dynamical system construction module 130 is to construct geometric dynamical systems involving velocity information respectively for the position motion task, the orientation motion task, and each of the obstacle avoidance motion tasks. The motion parameter acquisition module 140 is to obtain actual joint state information of the target robot in a current control cycle, as well as desired position information and desired orientation information of the robot end-effector of the target robot in the current control cycle corresponding to the desired operation. The local policy solving module 150 is to, based on an RMP pushforward operation, propagate the actual joint state information, the desired position information, and the desired orientation information from a root node of the RMP motion policy mapping tree to the geometric dynamical systems of the leaf node tasks, to solve for desired inertia matrices and desired forces, thereby obtaining local desired inertia matrices and local desired forces corresponding to the leaf node tasks, respectively.

The global policy solving module 160 is to, based on an RMP pullback operation, propagate the local desired inertia matrices and the local desired forces of the leaf node tasks to the root node to solve for joint accelerations, thereby obtaining a desired joint acceleration of the target robot in the current control cycle. The obstacle avoidance operation control module 170 is to control the target robot to move according to the desired joint acceleration.

Those skilled in the art will readily understand that, for the sake of convenience and conciseness in description, the specific working processes of the above-described device, modules, and units may refer to the corresponding processes in the foregoing method embodiments, and are not repeated herein.

In the above embodiments, the descriptions of each embodiment focus on different aspects. Any features not specifically described or disclosed in one embodiment may be referred to in the relevant descriptions of other embodiments.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. In addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented robot obstacle avoidance control method, comprising:
obtaining an actual spatial position of each of one or more obstacles currently present in an operating environment where a target robot is located;
constructing, based on the obtained one or more actual spatial positions, a corresponding Riemannian motion policy (RMP) motion policy mapping tree for the target robot, wherein a root node task of the RMP motion policy mapping tree corresponds to a robot joint space, and a plurality of leaf node tasks of the RMP motion policy mapping tree comprises a position motion task and an orientation motion task for a desired operation of a robot end-effector, as well as obstacle avoidance motion tasks in which a plurality of robot key parts comprising the robot end-effector performs obstacle avoidance with respect to each of the one or more obstacles;
constructing geometric dynamical systems involving velocity information respectively for the position motion task, the orientation motion task, and each of the obstacle avoidance motion tasks;
obtaining actual joint state information of the target robot in a current control cycle, as well as desired position information and desired orientation information of the robot end-effector of the target robot in the current control cycle corresponding to the desired operation;
based on an RMP pushforward operation, propagating the actual joint state information, the desired position information, and the desired orientation information from a root node of the RMP motion policy mapping tree to the geometric dynamical systems of the leaf node tasks, to solve for desired inertia matrices and desired forces, thereby obtaining local desired inertia matrices and local desired forces corresponding to the leaf node tasks, respectively;
based on an RMP pullback operation, propagating the local desired inertia matrices and the local desired forces of the leaf node tasks to the root node to solve for joint accelerations, thereby obtaining a desired joint acceleration of the target robot in the current control cycle; and
controlling the target robot to move according to the desired joint acceleration.

2. The method of claim 1, wherein constructing, based on the obtained one or more actual spatial positions, the corresponding Riemannian motion policy (RMP) motion policy mapping tree for the target robot, comprises:
decomposing a global motion task of the target robot in the robot joint space to obtain an orientation change task of the robot end-effector in an orientation space, a position change task of the robot end-effector in a position space, and position change tasks of the robot key parts other than the robot end-effector in corresponding position spaces;
decomposing the orientation change task of the robot end-effector in the orientation space into a task space of the robot end-effector to obtain the orientation motion task for performing the desired operation in the corresponding task space;
based on the one or more actual spatial positions, decomposing the position change task of the robot end-effector in the position space into the task space of the robot end-effector to obtain the position motion task for performing the desired operation in the corresponding task space, and obstacle avoidance motion tasks in which the robot end-effector performs obstacle avoidance with respect to the one or more obstacles;
based on the one or more actual spatial positions, decomposing the position change tasks of the robot key parts other than the robot end-effector into corresponding task spaces to obtain obstacle avoidance motion tasks in which the robot key parts other than the robot end-effector perform obstacle avoidance with respect to the one or more obstacles; and
constructing a tree structure based on spatial transformation relationships among the robot joint space, the orientation space, the position spaces, and the task spaces, for the global motion task, the orientation change task, all of the position change tasks, the orientation motion task, the position motion task, and all of the obstacle avoidance motion tasks, thereby obtaining the RMP motion policy mapping tree.

3. The method of claim 1, wherein the geometric dynamical systems corresponding to the position motion task, the orientation motion task, and each of the obstacle avoidance motion tasks each the satisfy following equations:
$$\{ \begin{matrix}( G ( x , \dot{x} ) + {Ξ}_{G} ( x , \dot{x} ) ) \ddot{x} + {ξ}_{G} ( x , \dot{x} ) = - {∇}_{x} Φ ( x ) - B ( x , \dot{x} ) \dot{x} \\ {Ξ}_{G} ( x , \dot{x} ) = \frac{1}{2} {\sum }_{i = 1}^{m} {\dot{x}}_{i} {\partial }_{\dot{x}} {g}_{i} ( x , \dot{x} ) \\ {ξ}_{G} ( x , \dot{x} ) = {G}^{x} ( x , \dot{x} ) \dot{x} - \frac{1}{2} {∇}_{x} ( {\dot{x}}^{T} G ( x , \dot{x} ) \dot{x} ) \\ {G}^{x} ( x , \dot{x} ) = {[ {\partial }_{x} {g}_{i} ( x , \dot{x} ) \dot{x} ]}_{i = 1}^{m}\end{matrix} ;$$
where G(x,\dot{x}) represents a geometric metric matrix corresponding to system state parameters (x,\dot{x}) of each of the geometric dynamical systems; B(x,\dot{x}) represents a damping matrix corresponding to the system state parameters (x,\dot{x}) of each of the geometric dynamical systems; Φ(x) represents a potential energy equation of each of the geometric dynamical systems; [symbol] _{G}(x,\dot{x}) represents a first curvature term matrix corresponding to the system state parameters (x,\dot{x}) of each of the geometric dynamical systems; [symbol] _{G}(x,\dot{x}) represents a second curvature term matrix corresponding to the system state parameters (x,\dot{x}) of each of the geometric dynamical systems; gᵢ(x,\dot{x}) represents a submatrix of an i-th column of G(x,\dot{x}); ∂ₓ represents a partial derivative with respect to a state parameter x; ∂_{\dot{x}} represents a partial derivative with respect to a state parameter \dot{x}; ∇ₓ represents a gradient with respect to the state parameter x; m represents a total number of columns in the matrix G(x,\dot{x}); the state parameter \dot{x} represents a differential of the state parameter x; and the state parameter \ddot{x} represents a differential of the state parameter \dot{x};
wherein in this process, the state parameters x and \dot{x} corresponding to position motion task represent, respectively, position information and position change velocity information of the robot end-effector; the state parameters x and i corresponding to the orientation motion task represent, respectively, orientation information and orientation change velocity information of the robot end-effector; and the state parameters x and \dot{x} corresponding to obstacle avoidance motion tasks represent, respectively, relative distance information and relative motion velocity information between the robot key parts and corresponding obstacles.

4. The method of claim 3, wherein the local desired inertia matrices and the local desired forces corresponding to the geometric dynamical systems are calculated according to the following equations:
$$\{ \begin{matrix}M ( x , \dot{x} ) = G ( x , \dot{x} ) + {Ξ}_{G} ( x , \dot{x} ) \\ f ( x , \dot{x} ) = M ( x , \dot{x} ) \ddot{x} = - {∇}_{x} Φ ( x ) - B ( x , \dot{x} ) \dot{x} - {ξ}_{G} ( x , \dot{x} )\end{matrix} ;$$
where M(x,\dot{x}) represents the local desired inertia matrices of the geometric dynamical systems corresponding to the system state parameters (x,\dot{x}), and f(x,\dot{x}) represents the local desired forces of the geometric dynamical systems corresponding to the system state parameters (x,\dot{x}).

5. The method of claim 1, wherein based on an RMP pullback operation, propagating the local desired inertia matrices and the local desired forces of the leaf node tasks to the root node to solve for joint accelerations, thereby obtaining the desired joint acceleration of the target robot in the current control cycle, comprises:
based on spatial transformation relationships among the root node and a plurality of leaf nodes within the RMP motion policy mapping tree, and based on the RMP pullback operation, propagating the local desired inertia matrices and local desired forces associated with the leaf node tasks to the root node, thereby obtaining the global desired inertia matrix and global desired force for the root node during the current control cycle; and
based on the global desired inertia matrix and the global desired force, calculating the desired joint acceleration for the target robot during the current control cycle.

6. The method of claim 5, wherein based on the global desired inertia matrix and the global desired force, calculating the desired joint acceleration for the target robot during the current control cycle comprises:
constructing a desired acceleration constraint condition for the joint acceleration of the target robot based on a joint limit motion position interval and a joint acceleration regulation interval of the target robot;
constructing, based on the global desired inertia matrix and the global desired force, a corresponding acceleration error function for the joint acceleration of the target robot; and
performing quadratic programming problem solving on the joint acceleration under an objective of minimizing an actual output magnitude of an acceleration error function, based on the target acceleration constraint condition, so as to obtain a desired joint acceleration of the target robot within the current control cycle.

7. The method of claim 6, wherein the target acceleration constraint condition is expressed by the following equation:
$$max ( {\ddot{q}}_{l} , \frac{2}{Δ {t}^{2}} ( {q}_{l} - {q}^{*} - {\dot{q}}^{*} Δ t ) ) \leq \ddot{q} \leq min ( {\ddot{q}}_{u} , \frac{2}{Δ {t}^{2}} ( {q}_{u} - {q}^{*} - {\dot{q}}^{*} Δ t ) ) ,$$
where q* represents an actual joint position included in the actual joint state information; \dot{q}* represents an actual joint velocity included in the actual joint state information; Δt represents a cycle duration of a single control cycle; qᵤ represents an upper limit value of a joint position included in the joint limit motion position interval; \ddot{q}ᵤ represents a lower limit value of the joint position included in the joint limit motion position interval; \ddot{q}ᵤ represents an upper limit value of a joint acceleration included in the joint acceleration regulation interval; \ddot{q}ₗ represents a lower limit value of the joint acceleration included in the joint acceleration regulation interval; and \ddot{q} represents the joint acceleration of the target robot;
wherein the acceleration error function is expressed by the following equation: (Mᵣ\ddot{q}−fᵣ)^{T}(Mᵣ\ddot{q}−fᵣ), where Mᵣ represents the global desired inertia matrix, and fᵣ represents the global desired force; and
wherein a quadratic programming problem expression for calculating the desired joint acceleration is expressed by the following equation:
$${min}_{\ddot{q}}$$
$$\begin{matrix}s . t . & max ( {\ddot{q}}_{l} , \frac{2}{Δ {t}^{2}} ( {q}_{l} - {q}^{*} - {\dot{q}}^{*} Δ t ) ) \leq \ddot{q} \leq min ( {\ddot{q}}_{u} , \frac{2}{Δ {t}^{2}} ( {q}_{u} - {q}^{*} - {\dot{q}}^{*} Δ t ) )\end{matrix} .$$

8. A robot control device comprising:
one or more processors; and
a memory coupled to the one or more processors, the memory storing programs that, when executed by the one or more processors, cause performance of operations comprising:
obtaining an actual spatial position of each of one or more obstacles currently present in an operating environment where a target robot is located;
constructing, based on the obtained one or more actual spatial positions, a corresponding Riemannian motion policy (RMP) motion policy mapping tree for the target robot, wherein a root node task of the RMP motion policy mapping tree corresponds to a robot joint space, and a plurality of leaf node tasks of the RMP motion policy mapping tree comprises a position motion task and an orientation motion task for a desired operation of a robot end-effector, as well as obstacle avoidance motion tasks in which a plurality of robot key parts comprising the robot end-effector performs obstacle avoidance with respect to each of the one or more obstacles;
constructing geometric dynamical systems involving velocity information respectively for the position motion task, the orientation motion task, and each of the obstacle avoidance motion tasks;
obtaining actual joint state information of the target robot in a current control cycle, as well as desired position information and desired orientation information of the robot end-effector of the target robot in the current control cycle corresponding to the desired operation;
based on an RMP pushforward operation, propagating the actual joint state information, the desired position information, and the desired orientation information from a root node of the RMP motion policy mapping tree to the geometric dynamical systems of the leaf node tasks, to solve for desired inertia matrices and desired forces, thereby obtaining local desired inertia matrices and local desired forces corresponding to the leaf node tasks, respectively;
based on an RMP pullback operation, propagating the local desired inertia matrices and the local desired forces of the leaf node tasks to the root node to solve for joint accelerations, thereby obtaining a desired joint acceleration of the target robot in the current control cycle; and
controlling the target robot to move according to the desired joint acceleration.

9. The robot control device of claim 8, wherein constructing, based on the obtained one or more actual spatial positions, the corresponding Riemannian motion policy (RMP) motion policy mapping tree for the target robot, comprises:
decomposing a global motion task of the target robot in the robot joint space to obtain an orientation change task of the robot end-effector in an orientation space, a position change task of the robot end-effector in a position space, and position change tasks of the robot key parts other than the robot end-effector in corresponding position spaces;
decomposing the orientation change task of the robot end-effector in the orientation space into a task space of the robot end-effector to obtain the orientation motion task for performing the desired operation in the corresponding task space;
based on the one or more actual spatial positions, decomposing the position change task of the robot end-effector in the position space into the task space of the robot end-effector to obtain the position motion task for performing the desired operation in the corresponding task space, and obstacle avoidance motion tasks in which the robot end-effector performs obstacle avoidance with respect to the one or more obstacles;
based on the one or more actual spatial positions, decomposing the position change tasks of the robot key parts other than the robot end-effector into corresponding task spaces to obtain obstacle avoidance motion tasks in which the robot key parts other than the robot end-effector perform obstacle avoidance with respect to the one or more obstacles; and
constructing a tree structure based on spatial transformation relationships among the robot joint space, the orientation space, the position spaces, and the task spaces, for the global motion task, the orientation change task, all of the position change tasks, the orientation motion task, the position motion task, and all of the obstacle avoidance motion tasks, thereby obtaining the RMP motion policy mapping tree.

10. The robot control device of claim 8, wherein the geometric dynamical systems corresponding to the position motion task, the orientation motion task, and each of the obstacle avoidance motion tasks each satisfy the following equations:
$$\{ \begin{matrix}( G ( x , \dot{x} ) + {Ξ}_{G} ( x , \dot{x} ) ) \ddot{x} + {ξ}_{G} ( x , \dot{x} ) = - {∇}_{x} Φ ( x ) - B ( x , \dot{x} ) \dot{x} \\ {Ξ}_{G} ( x , \dot{x} ) = \frac{1}{2} {\sum }_{i = 1}^{m} {\dot{x}}_{i} {\partial }_{\dot{x}} {g}_{i} ( x , \dot{x} ) \\ {ξ}_{G} ( x , \dot{x} ) = {G}^{x} ( x , \dot{x} ) \dot{x} - \frac{1}{2} {∇}_{x} ( {\dot{x}}^{T} G ( x , \dot{x} ) \dot{x} ) \\ {G}^{x} ( x , \dot{x} ) = {[ {\partial }_{x} {g}_{i} ( x , \dot{x} ) \dot{x} ]}_{i = 1}^{m}\end{matrix} ;$$
where G(x,\dot{x}) represents a geometric metric matrix corresponding to system state parameters (x,\dot{x}) of each of the geometric dynamical systems; B(x,\dot{x}) represents a damping matrix corresponding to the system state parameters (x,\dot{x}) of each of the geometric dynamical systems; Φ(x) represents a potential energy equation of each of the geometric dynamical systems; [symbol] _{G}(x,\dot{x}) represents a first curvature term matrix corresponding to the system state parameters (x,\dot{x}) of each of the geometric dynamical systems; ξ_{G}(x,\dot{x}) represents a second curvature term matrix corresponding to the system state parameters (x,\dot{x}) of each of the geometric dynamical systems; gᵢ(x,\dot{x}) represents a submatrix of an i-th column of G(x,\dot{x}); ∂ₓ represents a partial derivative with respect to a state parameter x; ∂_{\dot{x}} represents a partial derivative with respect to a state parameter \dot{x}; ∇ₓ represents a gradient with respect to the state parameter x; m represents a total number of columns in the matrix G(x,\dot{x}); the state parameter \dot{x} represents a differential of the state parameter x; and the state parameter \dot{x} represents a differential of the state parameter \dot{x};
wherein in this process, the state parameters x and \dot{x} corresponding to position motion task represent, respectively, position information and position change velocity information of the robot end-effector; the state parameters x and \dot{x} corresponding to the orientation motion task represent, respectively, orientation information and orientation change velocity information of the robot end-effector; and the state parameters x and \dot{x} corresponding to obstacle avoidance motion tasks represent, respectively, relative distance information and relative motion velocity information between the robot key parts and corresponding obstacles.

11. The robot control device of claim 10, wherein the local desired inertia matrices and the local desired forces corresponding to the geometric dynamical systems are calculated the according to following equations:
$$\{ \begin{matrix}M ( x , \dot{x} ) = G ( x , \dot{x} ) + {Ξ}_{G} ( x , \dot{x} ) \\ f ( x , \dot{x} ) = M ( x , \dot{x} ) \ddot{x} = - {∇}_{x} Φ ( x ) - B ( x , \dot{x} ) \dot{x} - {ξ}_{G} ( x , \dot{x} )\end{matrix} ;$$
where M(x,\dot{x}) represents the local desired inertia matrices of the geometric dynamical systems corresponding to the system state parameters (x,\dot{x}), and f(x,\dot{x}) represents the local desired forces of the geometric dynamical systems corresponding to the system state parameters (x,\dot{x}).

12. The robot control device of claim 8, wherein based on an RMP pullback operation, propagating the local desired inertia matrices and the local desired forces of the leaf node tasks to the root node to solve for joint accelerations, thereby obtaining the desired joint acceleration of the target robot in the current control cycle, comprises:
based on spatial transformation relationships among the root node and a plurality of leaf nodes within the RMP motion policy mapping tree, and based on the RMP pullback operation, propagating the local desired inertia matrices and local desired forces associated with the leaf node tasks to the root node, thereby obtaining the global desired inertia matrix and global desired force for the root node during the current control cycle; and
based on the global desired inertia matrix and the global desired force, calculating the desired joint acceleration for the target robot during the current control cycle.

13. The robot control device of claim 12, wherein based on the global desired inertia matrix and the global desired force, calculating the desired joint acceleration for the target robot during the current control cycle comprises:
constructing a desired acceleration constraint condition for the joint acceleration of the target robot based on a joint limit motion position interval and a joint acceleration regulation interval of the target robot;
constructing, based on the global desired inertia matrix and the global desired force, a corresponding acceleration error function for the joint acceleration of the target robot; and
performing quadratic programming problem solving on the joint acceleration under an objective of minimizing an actual output magnitude of an acceleration error function, based on the target acceleration constraint condition, so as to obtain a desired joint acceleration of the target robot within the current control cycle.

14. The robot control device of claim 13, wherein the target acceleration constraint condition is expressed by the following equation:
$$max ( {\ddot{q}}_{l} , \frac{2}{Δ {t}^{2}} ( {q}_{l} - {q}^{*} - {\dot{q}}^{*} Δ t ) ) \leq \ddot{q} \leq min ( {\ddot{q}}_{u} , \frac{2}{Δ {t}^{2}} ( {q}_{u} - {q}^{*} - {\dot{q}}^{*} Δ t ) ) ,$$
where q* represents an actual joint position included in the actual joint state information; \dot{q}* represents an actual joint velocity included in the actual joint state information; Δt represents a cycle duration of a single control cycle; qᵤ represents an upper limit value of a joint position included in the joint limit motion position interval; \ddot{q}ᵤ represents a lower limit value of the joint position included in the joint limit motion position interval; \ddot{q}ᵤ represents an upper limit value of a joint acceleration included in the joint acceleration regulation interval; \ddot{q}ₗ represents a lower limit value of the joint acceleration included in the joint acceleration regulation interval; and \ddot{q} represents the joint acceleration of the target robot;
wherein the acceleration error function is expressed by the following equation: (Mᵣ\ddot{q}−fᵣ)^{T}(Mᵣ\ddot{q}−fᵣ), where Mᵣ represents the global desired inertia matrix, and fᵣ represents the global desired force; and
wherein a quadratic programming problem expression for calculating the desired joint acceleration is expressed by the following equation:
$${min}_{\ddot{q}}$$
$$\begin{matrix}s . t . & max ( {\ddot{q}}_{l} , \frac{2}{Δ {t}^{2}} ( {q}_{l} - {q}^{*} - {\dot{q}}^{*} Δ t ) ) \leq \ddot{q} \leq min ( {\ddot{q}}_{u} , \frac{2}{Δ {t}^{2}} ( {q}_{u} - {q}^{*} - {\dot{q}}^{*} Δ t ) )\end{matrix} .$$

15. A non-transitory computer-readable storage medium storing instructions that, when executed by at least one processor of a robot control device, cause the at least one processor to perform a robot obstacle avoidance control method, the method comprising:
obtaining an actual spatial position of each of one or more obstacles currently present in an operating environment where a target robot is located;
constructing, based on the obtained one or more actual spatial positions, a corresponding Riemannian motion policy (RMP) motion policy mapping tree for the target robot, wherein a root node task of the RMP motion policy mapping tree corresponds to a robot joint space, and a plurality of leaf node tasks of the RMP motion policy mapping tree comprises a position motion task and an orientation motion task for a desired operation of a robot end-effector, as well as obstacle avoidance motion tasks in which a plurality of robot key parts comprising the robot end-effector performs obstacle avoidance with respect to each of the one or more obstacles;
constructing geometric dynamical systems involving velocity information respectively for the position motion task, the orientation motion task, and each of the obstacle avoidance motion tasks;
obtaining actual joint state information of the target robot in a current control cycle, as well as desired position information and desired orientation information of the robot end-effector of the target robot in the current control cycle corresponding to the desired operation;
based on an RMP pushforward operation, propagating the actual joint state information, the desired position information, and the desired orientation information from a root node of the RMP motion policy mapping tree to the geometric dynamical systems of the leaf node tasks, to solve for desired inertia matrices and desired forces, thereby obtaining local desired inertia matrices and local desired forces corresponding to the leaf node tasks, respectively;
based on an RMP pullback operation, propagating the local desired inertia matrices and the local desired forces of the leaf node tasks to the root node to solve for joint accelerations, thereby obtaining a desired joint acceleration of the target robot in the current control cycle; and
controlling the target robot to move according to the desired joint acceleration.

16. The non-transitory computer-readable storage medium of claim 15, wherein constructing, based on the obtained one or more actual spatial positions, the corresponding Riemannian motion policy (RMP) motion policy mapping tree for the target robot, comprises:
decomposing a global motion task of the target robot in the robot joint space to obtain an orientation change task of the robot end-effector in an orientation space, a position change task of the robot end-effector in a position space, and position change tasks of the robot key parts other than the robot end-effector in corresponding position spaces;
decomposing the orientation change task of the robot end-effector in the orientation space into a task space of the robot end-effector to obtain the orientation motion task for performing the desired operation in the corresponding task space;
based on the one or more actual spatial positions, decomposing the position change task of the robot end-effector in the position space into the task space of the robot end-effector to obtain the position motion task for performing the desired operation in the corresponding task space, and obstacle avoidance motion tasks in which the robot end-effector performs obstacle avoidance with respect to the one or more obstacles;
based on the one or more actual spatial positions, decomposing the position change tasks of the robot key parts other than the robot end-effector into corresponding task spaces to obtain obstacle avoidance motion tasks in which the robot key parts other than the robot end-effector perform obstacle avoidance with respect to the one or more obstacles; and
constructing a tree structure based on spatial transformation relationships among the robot joint space, the orientation space, the position spaces, and the task spaces, for the global motion task, the orientation change task, all of the position change tasks, the orientation motion task, the position motion task, and all of the obstacle avoidance motion tasks, thereby obtaining the RMP motion policy mapping tree.

17. The non-transitory computer-readable storage medium of claim 15, wherein the geometric dynamical systems corresponding to the position motion task, the orientation motion task, and each of the obstacle avoidance motion tasks each satisfy the following equations:
$$\{ \begin{matrix}( G ( x , \dot{x} ) + {Ξ}_{G} ( x , \dot{x} ) ) \ddot{x} + {ξ}_{G} ( x , \dot{x} ) = - {∇}_{x} Φ ( x ) - B ( x , \dot{x} ) \dot{x} \\ {Ξ}_{G} ( x , \dot{x} ) = \frac{1}{2} {\sum }_{i = 1}^{m} {\dot{x}}_{i} {\partial }_{\dot{x}} {g}_{i} ( x , \dot{x} ) \\ {ξ}_{G} ( x , \dot{x} ) = {G}^{x} ( x , \dot{x} ) \dot{x} - \frac{1}{2} {∇}_{x} ( {\dot{x}}^{T} G ( x , \dot{x} ) \dot{x} ) \\ {G}^{x} ( x , \dot{x} ) = {[ {\partial }_{x} {g}_{i} ( x , \dot{x} ) \dot{x} ]}_{i = 1}^{m}\end{matrix} ;$$
where G(x,\dot{x}) represents a geometric metric matrix corresponding to system state parameters (x,\dot{x}) of each of the geometric dynamical systems; B(x,\dot{x}) represents a damping matrix corresponding to the system state parameters (x,\dot{x}) of each of the geometric dynamical systems; Φ(x) represents a potential energy equation of each of the geometric dynamical systems; [symbol] G(x,\dot{x}) represents a first curvature term matrix corresponding to the system state parameters (x,\dot{x}) of each of the geometric dynamical systems; [symbol] _{G}(x,\dot{x}) represents a second curvature term matrix corresponding to the system state parameters (x,\dot{x}) of each of the geometric dynamical systems; gᵢ(x,\dot{x}) represents a submatrix of an i-th column of G(x,\dot{x}); ∂ₓ represents a partial derivative with respect to a state parameter x; ∂_{\dot{x}} represents a partial derivative with respect to a state parameter \dot{x}; ∇ₓ represents a gradient with respect to the state parameter x; m represents a total number of columns in the matrix G(x,\dot{x}); the state parameter \dot{x} represents a differential of the state parameter x; and the state parameter \ddot{x} represents a differential of the state parameter \dot{x};
wherein in this process, the state parameters x and \dot{x} corresponding to position motion task represent, respectively, position information and position change velocity information of the robot end-effector; the state parameters x and \dot{x} corresponding to the orientation motion task represent, respectively, orientation information and orientation change velocity information of the robot end-effector; and the state parameters x and \dot{x} corresponding to obstacle avoidance motion tasks represent, respectively, relative distance information and relative motion velocity information between the robot key parts and corresponding obstacles.

18. The non-transitory computer-readable storage medium of claim 17, wherein the local desired inertia matrices and the local desired forces corresponding to the geometric dynamical systems are calculated according to the following equations:
$$\{ \begin{matrix}M ( x , \dot{x} ) = G ( x , \dot{x} ) + {Ξ}_{G} ( x , \dot{x} ) \\ f ( x , \dot{x} ) = M ( x , \dot{x} ) \ddot{x} = - {∇}_{x} Φ ( x ) - B ( x , \dot{x} ) \dot{x} - {ξ}_{G} ( x , \dot{x} )\end{matrix} ;$$
where M(x,\dot{x}) represents the local desired inertia matrices of the geometric dynamical systems corresponding to the system state parameters (x,\dot{x}), and f(x,\dot{x}) represents the local desired forces of the geometric dynamical systems corresponding to the system state parameters (x,\dot{x}).

19. The non-transitory computer-readable storage medium of claim 15, wherein based on an RMP pullback operation, propagating the local desired inertia matrices and the local desired forces of the leaf node tasks to the root node to solve for joint accelerations, thereby obtaining the desired joint acceleration of the target robot in the current control cycle, comprises:
based on spatial transformation relationships among the root node and a plurality of leaf nodes within the RMP motion policy mapping tree, and based on the RMP pullback operation, propagating the local desired inertia matrices and local desired forces associated with the leaf node tasks to the root node, thereby obtaining the global desired inertia matrix and global desired force for the root node during the current control cycle; and
based on the global desired inertia matrix and the global desired force, calculating the desired joint acceleration for the target robot during the current control cycle.

20. The non-transitory computer-readable storage medium of claim 19, wherein based on the global desired inertia matrix and the global desired force, calculating the desired joint acceleration for the target robot during the current control cycle comprises:
constructing a desired acceleration constraint condition for the joint acceleration of the target robot based on a joint limit motion position interval and a joint acceleration regulation interval of the target robot;
constructing, based on the global desired inertia matrix and the global desired force, a corresponding acceleration error function for the joint acceleration of the target robot; and
performing quadratic programming problem solving on the joint acceleration under an objective of minimizing an actual output magnitude of an acceleration error function, based on the target acceleration constraint condition, so as to obtain a desired joint acceleration of the target robot within the current control cycle.
